(19) United States
(12) Patent Application Publication
(10) Pub. No.: US 2023/0324008 A1
(43) Pub. Date: Oct. 12, 2023

(54) GAS SUPPLY SYSTEM AND GAS SUPPLY METHOD

(71) Applicant: FUJIKIN INCORPORATED, Osaka (JP)

(72) Inventors: Takatoshi NAKATANI, Osaka-shi (JP); Atsushi HIDAKA, Osaka-shi (JP); Kazuyuki MORISAKI, Osaka-shi (JP); Kouji NISHINO, Osaka-shi (JP); Nobukazu IKEDA, Osaka-shi (JP)

(73) Assignee: FUJIKIN INCORPORATED, Osaka (JP)

(21) Appl. No.: 18/044,184

(22) PCT Filed: Oct. 5, 2021
(86) PCT No.: PCT/JP2021/036783

§ 371 Date: Mar. 6, 2023

(30) Foreign Application Priority Data
Oct. 31, 2020 (JP) 2020-183375

(51) Int. Cl. F17C 9/02; F17C 13/02

(52) U.S. Cl. CPC F17C 9/02; F17C 13/025; F17C 2250/043; F17C 2227/0302

(57) ABSTRACT

A gas supply system 100 comprises: a first vaporization supply device 10A including a first vaporization section 12A having a heater, a first valve 14A, and a first supply pressure sensor 16A for measuring a gas pressure between the first vaporization section and the first valve; a second vaporization supply device 10B including a second vaporization section 12B having a heater, a second valve 14B, and a second supply pressure sensor 16B for measuring a gas pressure between the second vaporization section and the second valve; and a control circuit 20. The system is configured to flow a gas from the first vaporization section 10A and a gas from the second vaporization section 10B sequentially into a common flow path, by shifting timings of an opening period of the first valve 14A and an opening period of the second valve 14B.

### TECHNICAL FIELD

The present invention relates to a gas supply system and a gas supply method, in particular, to a gas supply system and a gas supply method configured to be able to continuously supply a gas at a relatively large flow rate generated using a vaporization supply device.

### BACKGROUND ART

In a semiconductor manufacturing facility, a chemical plant, or the like, various process gas such as a source gas or an etching gas is supplied to a process chamber. As a device for controlling a flow rate of the supplied gas, a mass flow controller (thermal mass flow controller) or a pressure-type flow rate control device is known.

The pressure-type flow rate control device has been widely utilized (e.g., Patent Literature 1), because it is capable of controlling mass flow rates of various fluids with high accuracy by a relatively simple configuration of combining a control valve and a restriction part (e.g., an orifice plate or a critical nozzle) downstream of the valve. The pressure-type flow rate control device has excellent flow rate control characteristics, in which stable flow rate control can be performed even if the supply pressure on the primary side of the control valve fluctuates greatly.

In recent years, HCDS (Si₂Cl₆: Hexachlorodisilane) gas has been used as a material in the manufacture of semiconducting devices for forming insulating films such as silicon nitride films (SiNₓ films) and silicon oxide films (SiO₂ films). HCDS is a material that can be decomposed and reacted at low temperatures, which enables low temperature semiconductor fabrication processes at around 450-600° C.

However, since HCDS is a liquid (boiling point: about 144° C.) at room temperature, a liquid HCDS may be vaporized right before being supplied to the process chamber. A vaporization supply device that is available for HCDS or an organometallic material (e.g., TEOS: tetraethyl orthosilicate) is disclosed in Patent Literature 2 and Patent Literature 3 by the present applicant.

In the above described vaporization supply device, a liquid raw material of HCDS or an organometallic material is sent by pressure from a raw material tank to a vaporization section and heated by a heater in the vaporization section. A raw material gas generated in the vaporization section is supplied to a process chamber after being flow rate controlled by using a downstream control valve.

Same as in a conventional pressure-type flow rate control device, an opening degree of the control valve is feedback-controlled based on a pressure (sometimes referred to as an upstream pressure) upstream of a restriction part. By controlling the upstream pressure using the control valve in this manner, it is possible to flow the raw material gas generated in the vaporization section at a desired flow rate to a downstream side of the restriction part.

### PRIOR-ART DOCUMENT

### Patent Documents

Patent Literature 1: Japanese Patent No. 3546153
Patent Literature 2: International Publication No. 2019/021948
Patent Literature 3: International Publication No. 2021/054135

### SUMMARY OF INVENTION

### Technical Problem

However, in the pressure-type flow rate control accompanied with the control of the upstream pressure, although the flow rate control can be performed precisely, since the gas flows out through a restriction part, there is a disadvantage of being difficult to flow the gas at a large flow rate. When a restriction part is used, currently, HCDS gas can be flowed at only 1 SLM (Standard Liter/Min) even at the largest.

Furthermore, when attempting to supply the gas generated by the vaporization supply device at a large flow rate, a high gas generation capability of the vaporization supply device is also required. In addition, in order to perform the supply of an organometallic gas or an HCDS gas, the entire supply path is maintained at a high temperature of, for example, 200° C. or higher to prevent reliquification, so the system needs to be able to cope with a high temperature environment.

Therefore, when generating gas by using the vaporization supply device, there is demand for a system as a whole to supply a high temperature gas continuously and appropriately at a large flow rate (e.g., a flow rate of 2 SLM or more).

The present invention is made to solve the above problem, and its main object is to provide a gas supply system and a gas supply method capable of controlling and flowing an HCDS gas or an organometallic gas which is generated by using a vaporization supply device, at a relatively large flow rate.

### Solution to Problem

A gas supply system according to an embodiment of the present invention comprises: a first vaporization supply device including a first vaporization section for storing a raw material and having a heater, a first valve provided in a flow path downstream of the first vaporization section, and a first supply pressure sensor for measuring a gas pressure between the first vaporization section and the first valve: a second vaporization supply device including a second vaporization section for storing a raw material and having a heater, a second valve provided in a flow path downstream of the second vaporization section, a second supply pressure sensor for measuring a gas pressure between the second vaporization section and the second valve: and a control circuit connected to the first vaporization supply device and the second vaporization supply device, wherein the downstream flow path of the first vaporization supply device and the second vaporization supply device are communicated with a common flow path, and the control circuit is configured to control the opening/closing of the first valve and the second valve so as to shift the timings of an opening period of the first valve and an opening period of the second valve, to enable gas from the first vaporization section and the gas from the second vaporization section to flow sequentially into the common flow path.

In one embodiment, the system is configured to start flowing the gas from the first vaporization section into the common flow path by opening the first valve from a closed state, when an output of the first supply pressure sensor is a set value or greater, and start flowing the gas from the second vaporization section into the common flow path by opening the second valve from a closed state, when an output of the second supply pressure sensor is a set value or greater.

In one embodiment, the second valve is maintained in a closed state during the opening period of the first valve, and the first valve is maintained in a closed state during the opening period of the second valve.

In one embodiment, an overlap period at the time of switching is provided between the opening period of the first valve and the opening period of the second valve.

In one embodiment, the opening period of the first valve and the opening period of the second valve are provided so as to repeat alternately.

In one embodiment, the first vaporization section and the second vaporization section have the same shape and the same volume, the opening degree at the time of opening the first valve and the opening degree at the time of opening the second valve are the same, the opening period of the first valve and the opening period of the second valve are the same length.

In one embodiment, the raw material stored in the first vaporization section and the second vaporization section is a liquid organometallic material or a liquid Si₂Cl₆.

In one embodiment, the system further comprises a third vaporization supply device including a third vaporization section for storing a raw material and having a heater, a third valve provided downstream of the third vaporization section, and a third supply pressure sensor for measuring a gas pressure between the third vaporization section and the third valve. The third vaporization supply device is connected to the control circuit and a flow path downstream of the third vaporization supply device is communicated with the common flow path. The control circuit is configured to be able to sequentially flow the gas from the first vaporization section, the gas from the second vaporization section, and the gas from the third vaporization section into the common flow path, by shifting the timings of the opening periods of the first valve, the second valve and the third valve.

A gas supply method according to an embodiment of the present invention is performed in a gas supply system comprising a first vaporization supply device including a first vaporization section for storing a raw material and having a heater, a first valve provided in a flow path downstream of the first vaporization section, and a first supply pressure sensor for measuring a gas pressure between the first vaporization section and the first valve; a second vaporization supply device including a second vaporization section for storing a raw material and having a heater, a second valve provided in a flow path downstream of the second vaporization section, and a second supply pressure sensor for measuring a gas pressure between the second vaporization section and the second valve; and a control circuit connected to the first vaporization supply device and the second vaporization supply device, wherein the downstream flow path of the first vaporization supply device and the downstream flow path of the second vaporization supply device are communicated with a common flow path. The gas supply method comprises a step of opening the first valve from a closed state, and then closing the first valve from the opened state after a predetermined time has passed; a step of opening the second valve from a closed state at the same time as closing the first valve from the opened state, and then closing the second valve from the opened state after a predetermined time has passed; a step of opening the first valve from the closed state at the same time as closing the second valve from the opened state, and then closing the first valve from the opened state after a predetermined time has passed.

### Effect of Invention

According to the gas supply system and the gas supply method according to the embodiments of the present invention, it is possible to supply a gas generated in the vaporization supply device at a relatively large flow rate.

### BRIEF DESCRIPTION OF DRAWINGS

FIG. 1 is a diagram illustrating a configuration of a gas supply system according to an embodiment of the present invention.

FIG. 2 is a diagram illustrating an exemplary configuration of a vaporization supply device used in the gas supply system according to an embodiment of the present invention.

FIG. 3 is a graph illustrating changes in a valve control signal when opening/closing a downstream valve, and in the pressure of the gas generated by the vaporization supply device (supply pressure).

FIG. 4 is graphs illustrating a supply pressure, a valve control signal, and a gas flow rate in each of the first vaporization supply device and the second vaporization supply device.

FIG. 5 is a graph illustrating the flow rate of the gas supplied to the process chamber when performing the operation shown in FIG. 4.

FIG. 6 is a diagram illustrating a configuration of a gas supply system according to another embodiment of the present invention.

FIG. 7 is a diagram illustrating an operation control of a valve used in the gas supply system according to another embodiment of the present invention.

### DESCRIPTION OF EMBODIMENTS

In International Application Number PCT/JP2021/011117 (International Filing Date: Mar. 18, 2021), the present applicant discloses a method for measuring and controlling a supply amount when a gas generated in a vaporization supply device is supplied in a pulsed manner. The vaporization supply device used here is different from the conventional pressure-type flow rate control device, and does not need a restriction part, so control of the control valve is based on the measurement results of the gas pressure upstream of the control valve, i.e., the pressure of the gas generated in the vaporization section (hereinafter sometimes referred to as the supply pressure). In this case, the gas can be supplied without a restriction part, and the gas can flow at a relatively large flow rate.

However, in the above vaporization supply device, although pulsed gas supply at a relatively large flow rate is possible, it is impossible to supply gas for the next one pulse if not closing the control valve to generate gas and recover the supply pressure after performing the gas supply for one pulse, since the supply pressure upstream of the control valve continues to fall during the gas supply. Therefore, a recovery period of the supply pressure after the gas supply is essential, and it has been difficult to continuously supply the gas generated in the vaporization supply device.

In contrast, in the gas supply system according to the embodiment of the present invention described below, a plurality of vaporization supply devices connected in parallel to a common flow path leading to the process chamber are used to enable a continuous gas supply. More specifically, by sequentially shifting the timing of opening and closing of the control valve of each vaporization supply device, the gas can be continuously supplied at a relatively large flow rate from each vaporization supply device to the downstream side without using a restriction part.

Hereinafter, embodiments of the present invention will be described in detail with reference to the accompanying drawings, but the present invention is not limited to the embodiments described below.

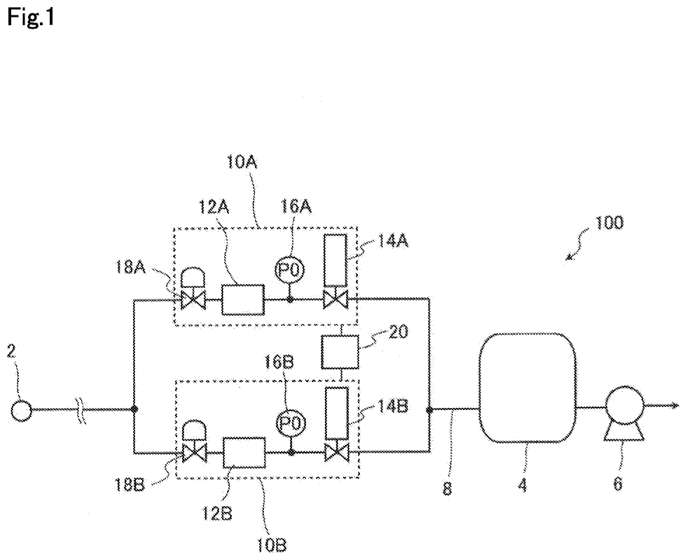

FIG. 1 illustrates a gas supply system 100 according to an embodiment of the present invention. The gas supply system 100 includes a plurality of vaporization supply devices connected in parallel on the upstream side with respect to a downstream common flow path 8, in this case, a first vaporization supply device 10A and a second vaporization supply device 10B. The first vaporization supply device 10A and the second vaporization supply device 10B are both connected to a control circuit 20 (or control board) and can be operated independently from each other by the control circuit 20.

In the illustrated embodiment, the control circuitry 20 is provided outside of the first vaporization supply device 10A and the second vaporization supply device 10B, but it may be provided in any manner as long as the operation of the first vaporization supply device 10A and the second vaporization supply device 10B can be controlled independently.

The control circuitry 20, may be incorporated in one of the first vaporization supply device 10A or the second vaporization supply device 10B, for example, or may be provided separately from the first vaporization supply device 10A and the second vaporization supply device 10B. In these cases, the first vaporization supply device 10A and the second vaporization supply device 10B are connected, and the control circuitry can control the operation of the first vaporization supply device 10A and the second vaporization supply device 10B. Further, the first vaporization supply device 10A, the second vaporization supply device 10B, and the control circuitry 20 may be provided integrally.

The upstream sides of the first vaporization supply device 10A and the second vaporization supply device 10B are connected to a liquid raw material source 2, which is a liquid raw material contained in a liquid storage tank, for example. In the present embodiment, the liquid raw material source 2 is commonly connected to both the first vaporization supply device 10A and the second vaporization supply device 10B. However, in another embodiment, the liquid raw material source 2 may be individually provided for the first vaporization supply device 10A and for the second vaporization supply device 10B.

As the liquid raw material, organometallic such as HCDS (Si₂Cl₆) or TEOS (tetraethylorthosilicate), TMGa (trimethylgallium), TMAl (trimethylaluminum) are being used. In the following embodiment, an example in which HCDS is vaporized and supplied will be described. The boiling point of HCDS is about 144° C., and the vapor pressure at 190° C. is about 250 kPa abs.

Downstream sides of the first vaporization supply device 10A and the second vaporization supply device 10B are communicating with a process chamber 4 via a common flow path 8. In the gas supply system 100, both the gas generated in the first vaporization supply 10A and the gas generated in the second vaporization supply 10B can be supplied to the process chamber 4. A vacuum pump 6 is connected to the process chamber 4 and can evacuate the process chamber 4 and a flow path communicating therewith.

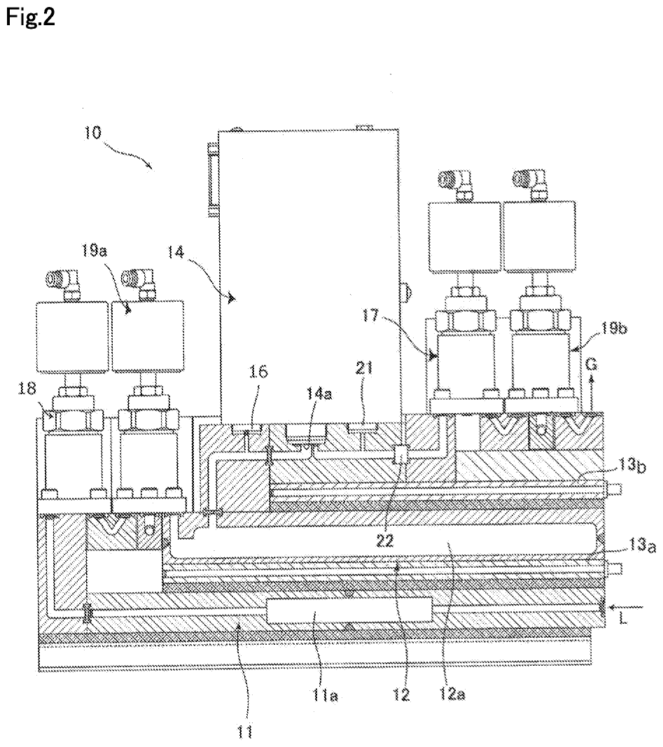

Next, the first vaporization supply device 10A and the second vaporization supply device 10B will be described referring to FIGS. 1 and 2. FIG. 2 illustrates a specific configuration of an exemplary vaporization supply device 10 used as the first vaporization supply device 10A and the second vaporization supply device 10B, it is a vertical vaporization supply device also described in Patent Literature 3.

As shown in FIG. 1, the first vaporization supply device 10A and the second vaporization supply device 10B include, respectively, a first and a second vaporization sections 12A, 12B, a first and a second valves 14A, 14B provided downstream of the first and the second vaporization sections 12A, 12B, and a first and a second supply pressure sensors 16A, 16B for measuring the supply pressures P0 upstream of the first and the second valves 14A, 14B (i.e. the pressures of the gases generated in the vaporization sections 12A, 12B). In addition, each of the first vaporization supply device 10A and the second vaporization supply device 10B of the present embodiment has respective first and second liquid replenishment valve 18A, 18B disposed upstream of the first and second vaporization section 12A, 12B.

When there is no particular need to distinguish, hereinafter, the first vaporization supply device 10A and the second vaporization supply device 10B are simply referred to as vaporization supply devices 10, the first and the second vaporization sections 12A, 12B are simply referred to as vaporization sections 12, the first and the second valve 14A, 14B are simply referred to as valves 14, the first and the second supply pressure sensors 16A, 16B are simply referred to as supply pressure sensors 16, the first and the second liquid replenishment valves 18A, 18B are sometimes simply referred to as liquid replenishment valves 18.

The vaporization section 12 of the vaporization supply device 10 is provided with a heater 13a (see FIG. 2), so it is possible to vaporize the supplied liquid raw material appropriately by controlling the heater 13a. When vaporizing the liquid raw material while the valve 14 is closed, the raw material is vaporized until the gas pressure (i.e., the supply pressure P0 measured by the supply pressure sensor 16) reaches a vapor pressure corresponding to the set heater temperature. For example, when HCDS is heated to 190° C. by the heater, HCDS is vaporized until the supply pressure P0 reaches approximately 250 kPa, which is the vapor pressure of the temperature. Then, it becomes saturated and the supply pressure P0 is maintained at approximately 250 kPa.

In the present embodiment, the valve 14 is a valve that is adjustable to any arbitrary opening degree (i.e., control valve), it is possible to control the flow rate of the gas generated in the vaporization section 12 by adjusting the opening degree. The valve 14 is configured using a piezo element driven valve (sometimes referred to as a piezo valve), for example. By controlling the driving voltage applied to the piezo element, the piezo valve can change the pressing force of the diaphragm valve element 14a (see FIG. 2) to the valve seat, thereby opening to any arbitrary opening degree.

The supply pressure sensor 16 provided between the vaporization section 12 and the valve 14 can measure the supply pressure P0, which is the pressure of the generated gas, for example, a pressure sensor of the type that measures the pressure from a magnitude of a strain generated in a diaphragm may be used. It is preferred that the valve 14 and the supply pressure sensor 16 can be operated without difficulty even in a high temperature environment of 150° C. to 250° C.

Further, as shown in FIG. 2, the vaporization supply device 10 may be provided with a preheating section 11 having a heater (not shown) upstream of the liquid replenishment valve 18. The preheating section 11 is provided for assisting the vaporization in the vaporization section 12, in the preheating section 11, by preheating a liquid raw material L introduced therein, the heat requirement in the vaporization section 12 may be lowered, and the temperature drop during vaporization may be suppressed.

In the vaporization supply device 10, as the heaters, a heater for heating the preheating section 11 from a side surface, a heater 13a for heating the vaporization section 12 from a side and bottom, and a heater 13b for heating the valve 14 and the downstream flow path from a side and bottom are provided. The preheating section 11, the vaporization section 12 and the valve 14 can be independently heated to any temperature. Normally, the heater temperature of the preheating section 11 is set lower than the heater temperature of the vaporization section 12, the heater temperature of the valve 14 is set higher than the heater temperature of the vaporization section 12.

The heater provided in each section of the vaporization supply device 10 is constituted by a heat transfer member and a heating element fixed thereto. As the heat transfer member, for example, a thick plate made of aluminum may be used. As the heating element, a cartridge heater or the like may be used. Further, in addition to this, a jacket heater may also be used as the heater.

In order to efficiently perform heating by the heater, the preheating section 11 has a preheating chamber 11a, which is an expanding section from the flow path, and is mainly heated by the heater. Further, the vaporization section 12 has a plate-shaped vaporization chamber 12a and is configured to vaporize the liquid raw material stored in the lower portion of the vaporization chamber 12a by the heater, and to flow the gas out from the gas outlet path provided on an upper surface.

Further, as illustrated in FIG. 2, the vaporization supply device 10 may be provided with a stop valve 17 provided downstream of the valve 14, a three-way valve 19a for purging provided between the liquid replenishment valve 18 and the vaporization section 12, a three-way valve 19b for purging provided downstream of the stop valve 17. The stop valve 17 is used to reliably stop the supply of gas from the vaporization supply device 10. As the liquid replenishment valve 18 and the stop valve 17, an AOV (air operated valve) or the like is preferably used.

The three-way valves 19a. 19b for purging are used for flowing a purge gas by switching, and an AOV or the like is preferably used for the three-way valves 19a, 19b. In the three-way valve 19a for purging, when the valve element is closed, the inlet of the purge gas is closed and the flow path of the liquid raw material is communicated with each other, and when the valve element is opened, the inlet of the purge gas is opened to communicate with the inside of the vaporization section, thereby allowing the purge gas to flow. In the three-way valve 19b for purging, when the valve element is closed, the inlet of the purge gas is closed and the downstream of the stop valve 17 is communicated with the process chamber, and when the valve element is opened, the inlet of the purge gas is opened to communicate with the process chamber, thereby allowing the purge gas to flow.

In the vaporization supply device 10 of the present embodiment shown in FIG. 2, as same as that in Patent Literature 3, a vertical configuration is used. Specifically, the vaporization section 12 is provided on the preheating section 11, the valve 14, or the stop valve 17 is provided on the vaporization section 12. However, the vaporization supply device 10 is not limited to the vertical configuration described above, as shown in Patent Literature 2, etc., the preheating section, the vaporization section, and the valve may be arranged in a row in the lateral direction. The vaporization supply device 10 may be configured in any manner so long as it has a vaporization section, a downstream valve (typically a control valve), and a supply pressure sensor between the vaporization section and the valve.

In addition, in the present embodiment, the downstream side of the valve 14 is connected to the stop valve 17 via a normal gasket 22. Different from the conventional pressure-type flow rate control device, since only the gasket 22 is arranged instead of providing a restriction part such as an orifice plate, it is easy to flow the gas at a large flow rate.

In this configuration, the control of the flow rate is performed on the basis of the output of the supply pressure sensor 16, as shown in FIG. 2, a pressure sensor 21 for measuring the pressure downstream of the valve 14 may be provided. In this case, it is possible to measure the differential pressure between the pressure primary side and the secondary side of the valve 14 from the output of the supply pressure sensor 16 and the output of the pressure sensor 21, it is also possible to determine the flow rate by calculation based on the measured differential pressure.

In the vaporization supply device 10 described above, the liquid raw material L from the liquid raw material source 2 is supplied to the vaporization section 12 or the preheating section 11 of the vaporization supply device 10. The liquid raw material L is pressurized and sent by, for example, supplying a pressured inert gas to the liquid storage tank, and pushing out the liquid raw material L at a constant pressure. The supply amount of the liquid raw material L to the vaporization section 12 is adjustable by controlling the opening/closing timing of the liquid replenishment valve 18.

In addition, in the vaporization section 12, the raw material gas G is generated by heating the liquid raw material L using a heater. By generating the gas with the valve 14 in the closed state, the supply pressure P0 increases to the vapor pressure. Thereafter, by opening the valve 14, it is possible to flow the raw material gas G downstream of the vaporization supply device 10 with the stop valve 17 in the open state.

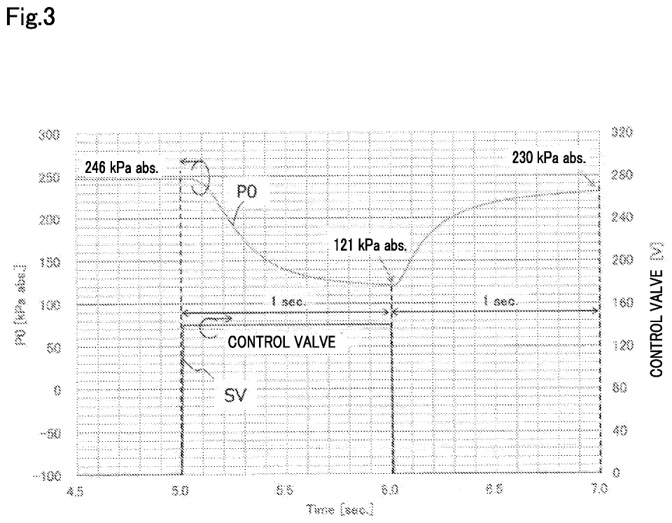

FIG. 3 is a graph illustrating a change in the supply pressure P0 when the valve 14 is opened for one pulse for a predetermined period (here 1 second) in accordance with a valve control signal SV based on a set flow rate, from a state where the supply pressure P0 is maintained at the vapor pressure (here 246 kPa abs.), in the vaporization supply device 10.

When the valve 14 is pulse opened in accordance with the valve control signaling SV, the gas accumulated upstream flows downstream through the valve 14. At this time, the valve 14 is opened to the maximum set opening degree (opening degree corresponding to 100% flow rate setting), for example, in accordance with the valve control signal SV.

As can be seen from FIG. 3, while the gas flows out to the downstream side of the valve 14, the supply pressure P0 decreases over time from the initial pressure after opening the valve 14. Then, after the gas supply for one pulse is completed, the valve control signal SV returns to 0%, the valve 14 is closed, then, since the gas generation is performed in the vaporization section 12 in a state where the valve 14 is closed, the supply pressure P0 is recovered.

Further, when the recovery period is 1 second, in the embodiment shown in FIG. 3, the supply pressure P0 is recovered only to 230 kPa degree, it takes a considerably long time afterward to reach the vapor pressure 246 kPa. However, if recovered to this degree, the next gas supply may be performed at a sufficient flow rate. Incidentally, any of the above supply pressure P0 is exemplary, it is needless to say that various values can be taken depending on the initial pressure (vapor pressure), the pulse opening/closing times, or the opening control method of the valve 14. However, usually, compared to the gas supply amount of the first time, the gas supply amount of the second and subsequent times are reduced.

In order to unify the gas supply amount, it is conceivable, for example, to set the opening degree of the piezo valve to a slightly smaller opening degree than the fully open state of 100% at the first time of opening, and to set the opening degree of the piezo valve to 100% at the time of opening from the second time onwards. It is also conceivable to set the opening time of the piezo valve at the first time shorter than the opening time of the piezo valves from the second time onwards. Alternatively, it is also conceivable to adjust the opening degrees and opening times of the piezo valve at the time of the subsequent pulsed gas supply each time in accordance with the magnitude of the supply pressure P0 after the recovery period.

However, when using the vaporization supply device 10 alone, it is difficult to supply the gas continuously to the process chamber 4 and a gas supply has to be pulsed. On the other hand, in the vaporization supply device 10, the gas supply amount flowing downstream of the valve 14 may be obtained from the measured supply pressure P0 when performing the gas supply. Therefore, if a pulsed supply is performed, the gas can be supplied with a controlled supply amount.

The method of obtaining the gas supply amount in a one pulse gas supply is disclosed in Applicant's International Application Number PCT/JP2021/011117. Specifically, first, a Cv (Coefficient of flow) when the valve 14 is opened to the maximum opening degree is determined. The Cv is a common indicator showing how easy the flow of the fluid in the valve is and corresponds to the flow rate of the gas flowing through the valve when the primary and secondary pressures of the valve are constant.

Under the condition that the primary pressure is sufficiently large with respect to the secondary pressure, typically more than two times larger, the flow rate Q (sccm) of the gas is expressed by, for example, Q=34500·Cv·P0/(Gg·T)^{1/2} using the Cv. In the above equation, Gg is the specific gravity of the gas, P0 is the supplied pressure or the primary pressure (kPa abs) of the valve, and T is the fluid temperature (K).

The Cv can be expressed by using the flow path cross-sectional area A of the valve and the contraction coefficient (contraction ratio) a, assuming that the flow path cross-sectional area A when the piezo valve is opened to the maximum opening degree is A=πDL, by using the seat diameter D (e.g., about 6 mm), and the valve element lifting quantity L (e.g., about 50 μm), then Cv=A·α/17=πDL·α/17.

If the Cv of the valve 14 is known, it is possible to determine the flow rate Q based on the supply pressure P0 as described above. By setting the gas supply amount (total volume or total material amount) in one pulse at the time when the valve 14 is opened for a predetermined time as the flow rate Q(tn) at the time tn (n is a natural number) of each sampling of the supply pressure P0, and setting the sampling period as dt, then the flow rate can be determined from ΣQ(tn)·dt=Q(t1) dt+Q(t2)·dt+ . . . +Q(tn)·dt).

As described above, if the pulsed gas supply is performed by each vaporization supply device 10, it is possible to flow the gas at a large flow rate or a large supply amount controlled by using the supply pressure sensor 16. Thus, if a plurality of the gas supply devices is provided to sequentially performing the gas supply, it is possible to continuously supply the gas at a controlled large flow rate.

Therefore, in the present embodiment, by alternately repeatedly performing the pulsed supply operation of the gas from the first vaporization supply device 10A and the pulsed supply operation of the gas from the second vaporization supply device 10B, the gas supply to the process chamber 4 can be performed continuously. By shifting the timing of the pulse opening period of the first valve 14A and the pulse opening period of the second valve 14B, the control circuit 20 can flow the gas from the first vaporizing section 12A and the gas from the second vaporization section 12B into the common channel 8 sequentially.

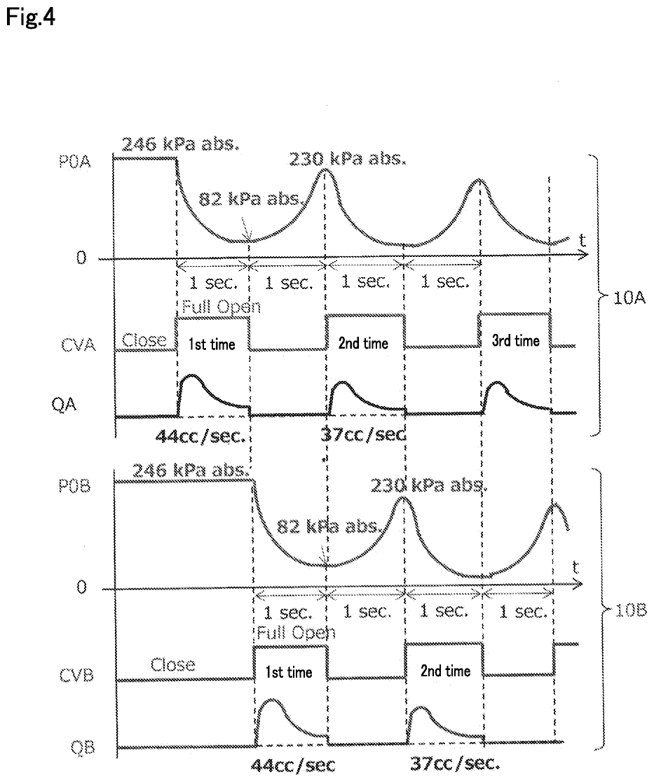

FIG. 4 illustrates the changes in the supply pressure POA in the first vaporization supply device 10A, the opening/closing signal CVA of the first valve 14A, the flow rate QA of the gas flowing to the downstream side of the first valve 14A and the changes in the supply pressure POB in the second vaporization supply device 10B, the opening/closing signal CVB of the second valve 14B, the flow rate QB of the gas flowing to the downstream side of the second valve 14B.

As can be seen from FIG. 4, initially from the state where both valves 14A, 14B are closed, and the supplied pressure POA. POB are maintained at the vapor pressure (246 kPa), first, only the first valve 14A is pulsed open for a predetermined period (here, for 1 second). At this time, the gas flows downstream of the first valve 14A, the supply pressure POA is rapidly reduced, and the flow rate QA fluctuates in a chevron wave form with an initial peak as illustrated. The gas supply amount corresponds to the time integral value of the flow rate QA.

On the other hand, in the above-mentioned period, the second valve 14B remains closed, and no gas is supplied from the second vaporization supply device 10B. Therefore, during this period, the gas supply is performed only from the first vaporization supply device 10A.

Nest, when the opening period of the first valve 14A (first time) is completed, together with the closing of the first valve 14A, only the second valve 14B is pulsed open for a predetermined period (here 1 second). At this time, the gas flows downstream of the second valve 14B, the supply pressure POB is rapidly reduced, and the flow rate QB fluctuates in a chevron wave form with an initial peak as illustrated. The gas supply amount corresponds to the time integral value of the flow rate QB.

On the other hand, in the above-mentioned period, the first valve 14A remains closed, and the gas is not supplied from the first vaporization supply device 10A. In addition, the supply pressure POA, which had dropped to 82 kPa when the first valve 14A was closed, recovers to 230 kPa as the generation of gas in the vaporization section 12A progresses.

Next, when the opening period of the second valve 14B (first time) is completed, together with the closing of the second valve 14B, the operation of pulsed opening only the first valve 14B for a predetermined period of time (here for 1 second) is performed again. At this time, similarly to the first time, the gas flows to the downstream side of the first valve 14A, and the supply pressure POA decreases. On the other hand, since the second valve 14B remains closed, the supply pressure POB, which has dropped to 82 kPa, recovers to 230 kPa as the generation of gas in the vaporization section 12B progresses.

Thereafter, similarly, when the opening period of the first valve 14A (second time) is completed, the operation of pulsed opening only the second valve 14B for only a predetermined period is performed again. In this way, the operation of opening only the first valve 14A for only a predetermined period, and the operation of opening only the second valve 14A for only a predetermined period are repeated sequentially. Thus, the supply of gas from the first vaporization section 12A and the supply of gas from the second vaporization section 12B are repeatedly performed alternately, which makes it possible to continuously supply the gas to the process chamber 4.

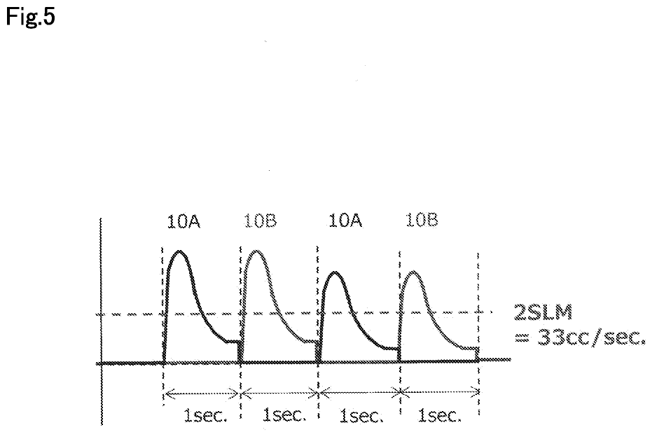

FIG. 5 is a diagram illustrating a temporal change in the flow rate of the gas supplied to the process chamber 4 by the operation control shown in FIG. 4. As can be seen from FIG. 5, the gas supply from the first vaporization supply device 10A and the gas supply from the second vaporization supply device 10B are performed repeatedly, which makes it possible to supply the gas to the process chamber 4 continuously.

During each period, although the flow rate fluctuates due to the decrease in the supply-pressure P0, on average, the gas supply can be performed continuously at a target of 2 SLM (≈33cc/sec). Incidentally, due to the difference in the initial pressure, the first gas supply amount of both of the first vaporization supply device 10A and the second vaporization supply device 10B are somewhat more than the second and subsequent gas supply amounts.

Further, as described above, from the measured supply pressure P0, which has decreased during the gas supply, the gas supply amount in one pulse can be determined. Therefore, it is also possible to determine the gas supply amount even when alternately performing pulsed gas supply from the first vaporization supply device 10A and the second vaporization supply device 10B. When the overall gas supply amount is shifted from the desired amount, by adjusting the opening degree and opening period of the control valve used as the valve 14, it is possible to perform gas supply in the desired amount.

However, when performing a continuous gas supply by combining a pulsed gas supply from a plurality of vaporization supply devices as described above, it is required that the initial pressure at the time of valve opening is equal to or greater than the set value (e.g., 200 kPa abs). Therefore, the control circuit 20 is configured to open the first valve 14A from the closed state to flow the gas from the first vaporization section 12A when the output of the first supply pressure sensor 16A is equal to or greater than the set value, similarly, to open the second valve 14B from the closed state to flow the gas from the second vaporization section 12B when the output of the second supply pressure sensor 16B is equal to or greater than the set value.

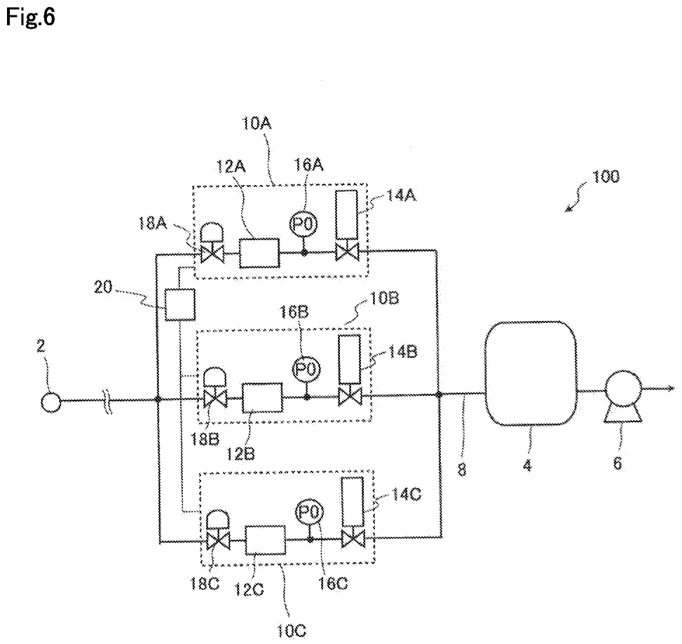

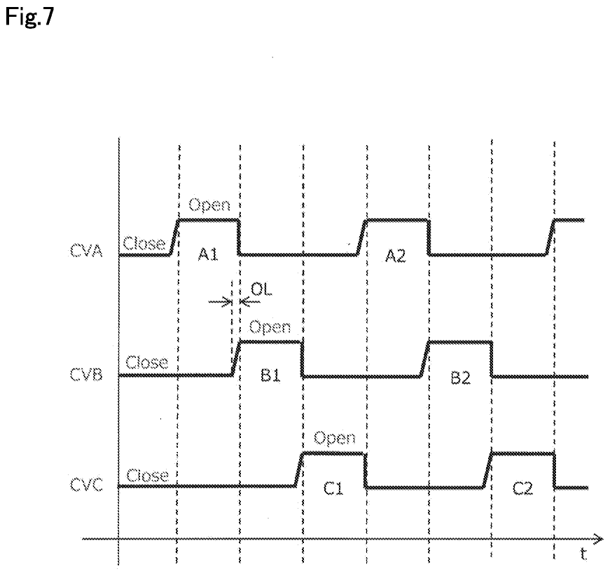

Hereinafter, with reference to FIGS. 6 and 7, a gas supply system according to another aspect will be described. FIGS. 6 and 7 illustrate the configuration of the gas supply system according to another aspect and the opening/closing signals of the valve applied. Incidentally, the same elements as in the above-described embodiment are denoted with the same reference numerals, and detailed description will be omitted.

In another gas supply system 100 illustrated in FIG. 6, in addition to the first vaporization supply device 10A and the second vaporization supply device 10B, a third vaporization supply device 10C is provided. The third vaporization supply device 10C is also communicated with the common flow path 8, and the first to third vaporization supply devices 10A, 10B, 10C are connected in parallel.

Same as the first and second vaporization supply devices 10A, 10B, the third vaporization supply device 10C includes a third vaporization section 12C having a heater, a third valve 14C downstream thereof, a third supply pressure sensor 16C for measuring the supply pressure P0 upstream of the third valve 14C, and a third liquid replenishment valve 18C for controlling the supply of the liquid to the third vaporization section 12C. The control circuitry 20 is connected to the first to third vaporization supply devices 10A, 10B, 10C.

As shown in FIG. 7, in the gas supply system 100 of the present embodiment, pulsed opening/closing signals CVA, CVB, CVC are given to each of the valves 14A, 14B, 14C, to sequentially open for a predetermined period by shifting the timing. In the illustrated embodiment, first, a period A1 is provided for opening the first valve 14A, then a period B1 is provided for opening the second valve 14B, and then a period C1 is provided for opening the third valve 14C.

Thereafter, at the timing of closing the third valve 14C, a period A2 for opening the first valve 14A is provided again, sequentially, a period B2 for opening the second valve 14B, and a third period C2 for opening the third valve 14C are provided again. In this manner, by supplying the gas sequentially and repeatedly from the first to third vaporization supply devices 10A, 10B, 10C, it is possible to continuously perform the gas supply at a controlled large flow rate to the process chamber 4.

Further, as shown in FIG. 7, in the present embodiment, a lamp control is performed when opening each of the valves 14, the control of the target opening degree of the valve is increased with time (control valve in this case). Further, the opening operation of the valves 14 by the lamp control is being executed in duplicate in the final stage of the opening period of the other valves. In this case, in the overlapping period OL, the two valves are opened simultaneously.

Thus, a slight overlap period may be provided to the opening/closing operation of the valves 14. For example, when maintaining the first valve 14A in the open state for a predetermined period A1, the second valve 14B is opened from the closed state at a timing prior to the ending of the predetermined period A1, then the second valve 14B is maintained open for a predetermined period B1. Similarly, the third valve 14C is opened from the closed state at a timing prior to the ending of the predetermined period B1, then the third valve 14C is maintained open for a predetermined period C1.

As shown in FIG. 4 etc., in the opening period of the respective valves, the supply pressure P0 continues to decrease, the flow rate Q at that time also gradually decreases after reaching the peak flow rate. In other words, the supply pressure P0 and the flow rate Q are lower than the initial value at the time just before the end of the opening period. For this reason, by duplicating the control of opening the other valves little by little as described above during the same period, it is possible to suppress a decrease in the supply-pressure P0 and the flow rate Q as a whole. Therefore, it is possible to control the flow rate stably transition.

The control of the opening degree of the valve at the time of the flow rate rising is not limited to the above-described lamp control. Various controls, such as a control in which the target value increases quadratically or exponentially, may be performed. In addition, similarly to the time of flow rate rising, even at the time of flow rate falling, it is also possible to perform a control in which the target opening degree decreases with time.

However, if the overlap period of the valve opening period described above is too long, the stable operation of the sequential gas supply from each vaporization supply device may be hindered. Therefore, it is preferable to set the timing of the opening start of the second valve in consideration of the output flow rate of the first vaporization supply device.

In this specification, the opening periods of the first valve and the second valve are not switched completely, even when including a slight overlap period as described above, it may be described that the operation of flowing the gas from the second vaporization section after opening the second valve only for a predetermined period of time is set being pushed back from the operation of flowing the gas from the first vaporization section after opening the first valve only for a predetermined period of time.

While embodiments of the present invention have been described above, various modifications are possible. For example, in order to stabilize the gas supply amount, the control signal applied to each valve may be corrected at any time based on the gas supply amount that is measured using the supply pressure sensor. Specifically, when supplying the first one pulse gas at the start of the process, together with performing the opening/closing of the valve 14 based on the predetermined pulse flow rate control signal (valve opening/closing command), the gas supply amount of one pulse is measured by the gas supply amount measurement method described above. Then, in the case where the measured gas supply amount has a significant difference with respect to the desired set gas supply amount, the pulse flow control signal is corrected from the next one pulse gas supply to control the opening/closing operation of the valve 14 in the next and subsequent pulses.

For example, when the measured gas supply amount is larger than the preset desired amount, at least one of the opening time of the valve 14 and the opening degree of the valve 14 is set to a smaller value. This makes it possible to reduce the gas supply amount in the next one pulse gas supply, and to perform the gas supply in the desired amount. On the other hand, when the measured gas supply amount is smaller than the desired amount, at least one of the opening time of the valve 14 and the opening degree of the valve 14 is set to a larger value. This makes it possible to increase the gas supply amount in the next one pulse gas supply, and to perform the gas supply in the desired amount.

As described above, by using an opening degree adjustable control valve as the valve 14, and by arbitrarily setting the opening degree during the opening time of the control valve, the advantage of the overall flow rate control, and easy to fine adjustment of the flow rate can be obtained. However, in applications where fine adjustment of the flow rate by the opening degree adjustment or the like is not required, an on-off valve having only the opening/closing function as the valve 14.

In addition, the above description is explained on the assumption that the liquid replenishment valve 18 is closed during the gas supply period. However, the liquid raw material inside the vaporization section 12 as the gas supply proceeds will be consumed. Thus, if the liquid is not replenished, the supply pressure P0 does not return to a sufficiently large level even during the same restoration period. Therefore, the supply pressure P0 may be monitored, for example, to replenish the liquid raw material to the vaporizing section 12 by opening the liquid replenishing valve 18 for a predetermined period, when the supply pressure P0 after the restoration period falls below a set threshold value, or to replenish the liquid raw material based on the value of the liquid level gauge provided in the vaporization section 12 or the supplied gas amount.

Furthermore, the above description explained examples of configuring the gas supply system using two or three vaporization supply devices connected in parallel, of course it is also possible to configure the gas supply system using four or more vaporization supply devices.

### INDUSTRIAL APPLICABILITY

The gas supply system according to an embodiment of the present invention is suitably utilized to continuously supply a relatively large flow rate of gas used in the semiconductor manufacturing process.

### REFERENCE SIGNS LIST

2 Liquid raw material source
4 Process chamber
6 Vacuum pump
8 Common flow path
10 Vaporization supply device
10A First vaporization supply device
10B Second vaporization supply device
12 Vaporization section
12A First vaporization section
12B Second vaporization section
14 Valve
14A First valve
14B Second valve
16 Supply pressure sensor
16A First supply pressure sensor
16B Second supply pressure sensor
18 Liquid replenishment valve
18A First fluid replenishment valve
18B Second fluid replenishment valve
20 Control circuit
100 Gas supply system

1. A gas supply system comprising:
a first vaporization supply device including a first vaporization section for storing a raw material and having a heater, a first valve provided in a flow path downstream of the first vaporization section, and a first supply pressure sensor for measuring a gas pressure between the first vaporization section and the first valve;
a second vaporization supply device including a second vaporization section for storing a raw material and having a heater, a second valve provided in a flow path downstream of the second vaporization section, and a second supply pressure sensor for measuring a gas pressure between the second vaporization section and the second valve; and
a control circuit connected to the first vaporization supply device and the second vaporization supply device;
wherein a downstream flow path of the first vaporization supply device and a downstream flow path of the second vaporization supply device are communicated with a common flow path, and
the control circuit is configured to control the opening/closing of the first valve and the second valve to shift a timing of opening the first valve and a timing of opening the second valve, and to flow the gas from the first vaporization section and the gas from the second vaporization section sequentially to the common flow path.

2. The gas supply system according to claim 1, configured so as to start flowing the gas from the first vaporization section to the common flow path by opening the first valve from a closed state when an output of the first supply pressure sensor is a set value or more; and to start flowing the gas from the second vaporization section to the common flow path by opening the second valve from a closed state when an output of the second supply pressure sensor is a set value or more.

3. The gas supply system according to claim 2, wherein the second valve is maintained in a closed state during the opening period of the first valve, and the first valve is maintained in a closed state during the opening period of the second valve.

4. The gas supply system according to claim 2, wherein an overlap period at time of switching is provided between the opening period of the first valve and the opening period of the second valve.

5. The gas supply system according to claim 1, wherein the opening period of the first valve and the opening period of the second valve are provided so as to repeat alternately.

6. The gas supply system according to claim 1, wherein the first vaporization section and the second vaporization section have a same shape and a same volume, the opening degree at the time of opening the first valve and the opening degree at the time of opening the second valve are same, and the opening period of the first valve and the opening period of the second valve are same length.

7. The gas supply system according to claim 1, wherein the raw material stored in the first vaporization section and the second vaporization section is a liquid metalorganic material or a liquid Si2Cl6.

8. The gas supply system according to claim 1, further comprising a third vaporization supply device including a third vaporization section for storing a raw material and having a heater, a third valve provided downstream of the third vaporization section, and a third supply pressure sensor for measuring a gas pressure between the third vaporization section and the third valve, the third vaporization supply device being connected to the control circuit and a downstream flow path of the third vaporization supply being communicated with the common flow path,
wherein the control circuit is configured to be able to flow the gas from the first vaporization section, the gas from the second vaporization section, and the gas from the third vaporization section sequentially to the common flow path, by shifting timings of the opening periods of the first valve, the second valve, and the third valve.

9. A gas supply method performed in a gas supply system comprising:
a first vaporization supply device including a first vaporization section for storing a raw material and having a heater, a first valve provided in a flow path downstream of the first vaporization section, and a first supply pressure sensor for measuring a gas pressure between the first vaporization section and the first valve;
a second vaporization supply device including a second vaporization section for storing a raw material and having a heater, a second valve provided in a flow path downstream of the second vaporization section, and a second supply pressure sensor for measuring a gas pressure between the second vaporization section and the second valve; and
a control circuit connected to the first vaporization supply device and the second vaporization supply device,
wherein a downstream flow path of the first vaporization supply device and a downstream flow path of the second vaporization supply device are communicated with a common flow path,
the gas supply method comprising:
a step of opening the first valve from a closed state and then closing the first valve from an opening state after a predetermined time has passed;
a step of opening the second valve from a closed state at the same time as closing the first valve from an opening state and then closing the second valve from an opening state after a predetermined time passes; and
a step of opening the first valve from a closed state at the same time as closing the second valve from an opening state and then closing the first valve from an opening state after a predetermined time has passed.
